(19) United States
(12) Patent Application Publication
(10) Pub. No.: US 2025/0368526 A1
(43) Pub. Date: Dec. 4, 2025

(54) Bi-Metallic Rare Earth Oxide Nanomaterials

(71) Applicant: UNIVERSITY OF CENTRAL FLORIDA RESEARCH FOUNDATION, INC., Orlando, FL (US)

(72) Inventors: Sudipta SEAL, Orlando, FL (US); Craig NEAL, Orlando, FL (US)

(21) Appl. No.: 19/223,534

(22) Filed: May 30, 2025

Related U.S. Application Data
(60) Provisional application No. 63/653,358, filed on May 30, 2024.

(51) Int. Cl. C01F 17/32; B82Y 40/00

(52) U.S. Cl. CPC C01F 17/32; B82Y 40/00; C01P 2002/01; C01P 2002/85; C01P 2004/04; C01P 2004/32; C01P 2004/64

(57) ABSTRACT

Disclosed are nanomaterials that are comprised of RₓO_{y}M¹M² clusters, where R is one or more lanthanides selected from La, Ce, Pr, Nd, Pm, Sm Eu, Gd, Tb, Dy, Ho, Er, Tm, Yb or Lu, wherein O is oxygen and where M¹ and M² are metallic components selected from Sc, Ti, V, Cr, Mn, Fe, Co, Ni, Cu, Zn, Y, Zr, Nb, Mo, Tc, Ru, Rh, Pd, Ag, or Cd, or a metal oxide of the foregoing transition metals.

### BACKGROUND

Catalysts can be used to change the rates and control the yields of chemical reactions to increase the amounts of desirable products from these reactions and reduce the amounts of undesirable ones. For example, cerium (IV) oxide (CeO₂) (also referred to as ceria) can be used in catalytic converters for reducing carbon monoxide emissions in exhaust gases from motor vehicles. Cerium exists in both trivalent state (+3) and tetravalent (+4) state and may switch between the two in reduction and oxidation reactions. Cerium (IV) oxide can be reduced by carbon monoxide to cerium (III) oxide:

2CeO₂+CO→Ce₂O₃+CO₂,
and cerium (III) oxide can be oxidized to cerium (IV) oxide:

2Ce₂O₃+O₂→4CeO₂.

Cerium oxide is also useful in three-way catalysis, petroleum cracking, water gas shift reaction, fuel cells, and synthetic organic chemistry. More recently, biomedical applications of nanomaterials, such as in surface disinfection, or even therapeutic administration is being realized. It has been proposed that the catalytic traits of cerium oxide can be attributed to two properties of ceria: (i) the high mobility and storage capacity of oxygen within the lattice, and (ii) the ease with which cerium changes between Ce³⁺ and Ce⁴⁺ states to allow the high oxygen mobility within the oxide lattice. These properties, combined with the abundance of cerium on earth, make ceria a low-cost and effective alternative to noble metal catalysts. There is a need to further develop lanthanide oxide based materials for biomedical applications having diverse functions and properties.

### BRIEF DESCRIPTION OF DRAWINGS

FIG. 1: Transmission Electron Microscopy images of Bi-Metallic Nano rare Earth Oxide particle (77WC) formulations. Nano rare Earth Oxide particle (77WC) formulations. A representative formulation was synthesized and is noted here as formulation (1). Particles are largely crystalline, as evidenced by observable lattice fringes. These fringes, along with variation in relative crystallite sizes, suggest formation of the bi-metallic surface phases. Additional formulations may further be synthesized, in fixed nominal compositions, by dissimilar wet chemical syntheses. Differences in particle character among representative formulations will confer the ability to tune a given bi-metallic nano rare earth oxide composition's physicochemical character through modification of synthesis approach. Designed changes to these characters may then be considered for varied, specific applications.

FIG. 2: Chemical state analysis of bi-metallic nanomaterials. X-ray photoelectron spectroscopy (XPS) measurements (FIG. 2A, survey scan over a relevant binding energy region) with binding energy regions for Ce3d (FIG. 2B), Ag3d (FIG. 2C), and Zn2p (FIG. 2D) chemical states. Peak fittings to Ce³⁺ and Ce⁴⁺ states provide insight into the density of oxygen vacancies at the material surface and thereby their unique redox chemistry. Integration of the peak areas demonstrates that the majority of (near-) surface cerium sites are in the reduced state: suggesting a substantial density of surface vacancy sites at which catalytic redox reactions may occur. Interestingly, silver (FIG. 2C) content in the nanoparticle formulation is observed in a metallic state while zinc (FIG. 2D) occurs in both metallic and oxide states. The presence of multiple metal elements (cerium, silver, zinc) in mixed valence states (0, +2, +3, +4) further suggests complex bond structures and interfaces or doping among the varied material components. The range of component valencies may also contribute to observed antimicrobial activates via associated redox reactions such as the generation of free radicals by engineered nanoceria formulations.

### DETAILED DESCRIPTION

### Overview

Multi-metal clustering of nano-rare earth oxide (RO, where R is varied from La, Ce to Lu) particles, which initiates complex electron transfer can enable many catalytic reactions. This leads to fast redox active nanoparticles for modulating reactive oxygen species. Combination of various bi-metallic combinations includes transition group of elements from Sc to Cd (2 to 20 at %) (example: Cu—Zn/RO, Zn—Cd/RO, etc). The chosen bi-metallic components will have limited solid solubility in the nano-rare earth oxide component and will tend to localize towards the rare earth oxide surface at lower bi-metallic component concentrations. When the bi-metallic component concentrations are greater, surface phases may be comparable in size to the rare earth oxide component. The bi-metallic component of the material will participate in fast redox reactions through function as binding sites for chemical substrates and/or mediators of electron transfer within a given chemical reaction. This multi-metal clustering creates more asymmetric oxygen vacancies in host nano-rare earth oxide lattices promotes faster electron transport. This leads to superior catalytic performance for biomedical applications.

### Definitions

Unless specifically stated or obvious from context, as used herein, the term “about” is understood as within a range of normal tolerance in the art, for example within 2 standard deviations of the mean. About can be understood as within 30%, 25%, 20%, 15%, 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

### DESCRIPTION OF EXEMPLARY EMBODIMENTS

According to certain embodiments, provided are nanomaterials that are comprised of RₓO_{yM}¹M² clusters, where R is one or more lanthanides selected from La, Ce, Pr, Nd, Pm, Sm Eu, Gd, Tb, Dy, Ho, Er, Tm, Yb or Lu, wherein O is oxygen and where M¹ and M² are metallic components selected from Sc, Ti, V, Cr, Mn, Fe, Co, Ni, Cu, Zn, Y, Zr, Nb, Mo, Tc, Ru, Rh, Pd, Ag, or Cd, or a metal oxide of the foregoing transition metals. M¹ and M² typically comprise different metals, or alternatively, M¹ might be a metal and M² a metal oxide of the same metal of M¹ (e.g., M¹ is zinc and M² is zinc oxide). Moreover, M¹ and/or M² may include a metal and a metal oxide of the same metal. In a certain embodiment, the M¹M² content is about 2% to about 20%, molar percent of the nanomaterial. X may be 1-3 and y may be 1-3. In an embodiment, nanomaterials comprise nanoparticles having a particle size of the range of from 1 nm to 100 nm or from 5 nm to 100 nm or from 5 nm to 25 nm.

The RₓO_{y}M¹M² nanomaterial are particles, where the particles may be spherical, rod-shaped, star-shaped, or polygonal. In a preferred embodiment, the particles are spherically-shaped, meaning that they more or less approximate the shape of a sphere. Preferably, the average diameter of the spherically-shaped particles is about 20-70 nm. In a certain embodiment, the spherically-shaped lanthanide oxide nanoparticles have an average diameter of 30 nm to 50 nm as measured by transmission electron microscopy. In embodiments in which the particles are not spherically shaped, it is preferred that the average dimension between two opposing sides of the nanoparticles is 50 nm or less.

The RₓO_{y}M¹M² nanoparticles will have a lanthanide oxide core with an external surface. The surface is characterized by having different constituents in different valence states, i.e., mixed valence states. For example, M¹ and M² may comprises a valence state selected from 0, +2, +3, or +4, or a combination thereof, where the valence state of M¹ and M² is the same or different. Similarly, R may comprise a valence state selected from +3, +4, or a combination thereof. Although the amount is not intended to be limiting, when used in methods of the invention, some preferred ranges of R (3+):R (4+) percentages are: about 80%: 20% to about 20%: 80%, about 75%: 25% to about 25%: 75%, about 60%: 40% to about 25%: 75%, or about 57%: 43% to about 27%: 73%. In certain embodiments, the percentage of R (3+) relative to R (4+) is >50% R (3+). In a specific embodiment, R is Ce.

According to another embodiment, provided is a method of producing RₓO_{y}M¹M² nanoparticles. The method involves dissolving a lanthanide salt (e.g. Ce(NO3)3) in water to form a lanthanide solution at a concentration of 5 mM to about 50 mM; dissolving a first metal salt in water and a second metal salt in water at concentrations up to 20 mol % for each metal component (the first metal salt and second metal salt may be dissolved in the same or different solutions); hydrolyzing the lanthanide to form lanthanide oxide; and mixing the first metal and second metal salt solution(s) with the lanthanide solution during the hydrolyzing step to form a lanthanide/metal mixture; and aging lanthanide/metal mixture to form RₓO_{y}M¹M² nanoparticles. Aging involves storing the mixture for a period of time to allow for formation of the nanoparticles, and may also involve subjecting the mixture to an oxidizing agent known in the art.

### EXAMPLES

### Example 1: Production of Bi-Metal Cerium Oxide Particles

Synthesis Procedure. A cerium precursor salt, such as Ce(NO₃)₃, is dissolved in de-ionized water to a final concentration of 5 to 50 mM. Additional metal (e.g., silver, zinc, zirconium) salts are similarly dissolved to various concentrations, up to 20 mol %, for each component, in de-ionized water and combined with the dissolved cerium salt. The aqueous cerium ion components are then allowed to undergo hydrolysis at elevated or autogenic pH. Hydrolysis and consequent metal oxide particle formation may be accelerated through addition of an oxidizing agent such as hydrogen peroxide (e.g., at a final concentration of at least (0.1 v/v %). Additional metal component, ts are incorporated with the forming cerium oxide phase as dopants and surface phases. Choice of additional metal components, based on respective solubilities in the cerium oxide parent material, allows control over doping versus non-doping, or surface segregating, behaviors. Additionally, choice of pairs of additional metal species will allow control of particle electrochemical properties through band or work function tuning (e.g., choice of metal species based on their individual standard electrochemical positions). The choice of metal species may also allow efficient chemical transformations, such as for catalytic Zn—Pd intermetallic structures at zinc support surfaces or Ru/Pd structures, with each species contributing to the catalytic pathway. Particles may be aged, in situ or with application of some physicochemical process such as heating, following addition of all reaction components to allow equilibration of particle phase compositions (e.g., decomposition of surface adsorbed peroxide species).

Those skilled in the art will appreciate that other lanthanide precursor salts and metal salts can be substituted for the cerium precursor salt described in the above example.

### Example 2

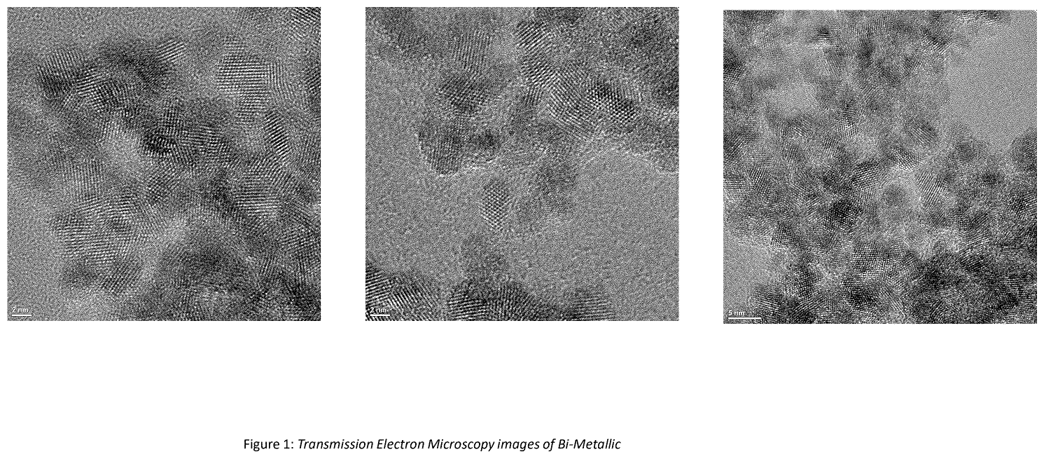

As shown in FIG. 1, a representative formulation was synthesized and is noted here as formulation (1), with the nominal molar proportions of metal components as Zn:Ag:Ce->1:1:10. The formulation was analyzed using Transmission Electron Microscopy. Particles are largely crystalline, as evidenced by observable lattice fringes. These fringes, along with variation in relative crystallite sizes, suggest formation of the bi-metallic surface phases. Additional formulations may further be synthesized, in fixed nominal compositions, by dissimilar wet chemical syntheses. Differences in particle character among representative formulations will confer the ability to tune a given bi-metallic nano rare earth oxide composition's physicochemical character through modification of synthesis approach. Designed changes to these characters may then be considered for varied, specific applications.

### Example 3

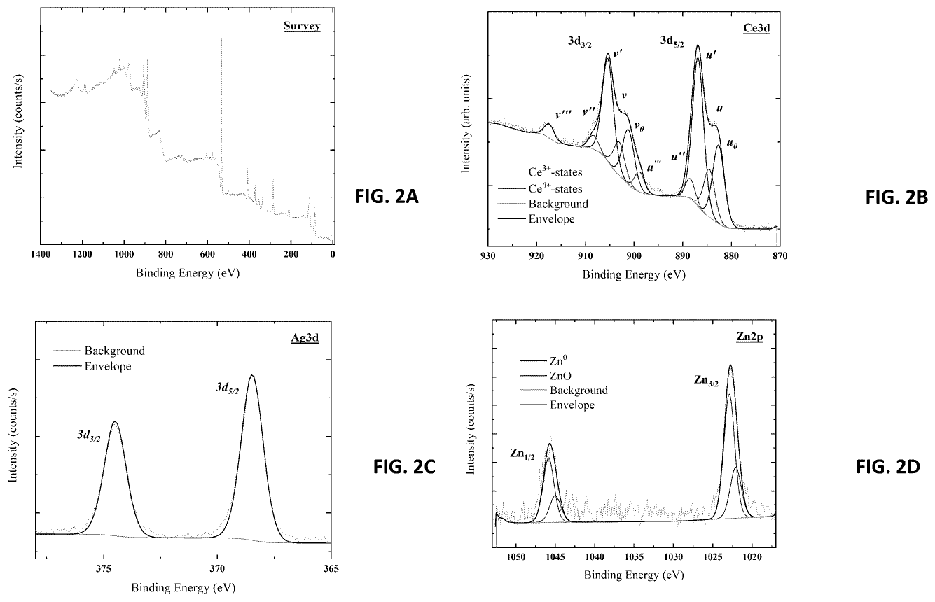

As shown in FIG. 2, X-ray photoelectron spectroscopy (XPS) measurements were taken (A, survey scan over a relevant binding energy region) with binding energy regions for Ce3d (B), Ag3d (C), and Zn2p (D) chemical states. Peak fittings to Ce³⁺ and Ce⁴⁺ states provide insight into the density of oxygen vacancies at the material surface and thereby their unique redox chemistry. Integration of the peak areas demonstrates that the majority of (near-) surface cerium sites are in the reduced state: suggesting a substantial density of surface vacancy sites at which catalytic redox reactions may occur. Interestingly, silver (C) content in the nanoparticle formulation is observed in a metallic state while zinc (D) occurs in both metallic and oxide states. The presence of multiple metal elements (cerium, silver, zinc) in mixed valence states (0, +2, +3, +4) further suggests complex bond structures and interfaces or doping among the varied material components. The range of component valencies may also contribute to observed antimicrobial activates via associated redox reactions such as the generation of free radicals by engineered nanoceria formulations.

What is claimed is:

1. A nanomaterial comprised of RₓO_{y}M¹M², where R is one or more lanthanides selected from La, Ce, Pr, Nd, Pm, Sm Eu, Gd, Tb, Dy, Ho, Er, Tm, Yb or Lu, wherein O is oxygen and where M¹ and M² are metallic components selected from Sc, Ti, V, Cr, Mn, Fe, Co, Ni, Cu, Zn, Y, Zr, Nb, Mo, Tc, Ru, Rh, Pd, Ag, or Cd, or a metal oxide thereof, wherein x is 1-3 and y is 1-3.

2. The nanomaterial of claim 1, wherein M¹ and M² comprise different metals, or alternatively, M¹ is a metal and M² is a metal oxide of M¹.

3. The nanomaterial of claim 1, wherein the M¹M² content is about 2% to about 20%, molar percent of the nanomaterial.

4. The nanomaterial of any of claims 1-4, wherein the nanomaterial comprises particles having a particle size of the range of from 1 nm to 100 nm or from 5 nm to 100 nm or from 5 nm to 25 nm.

5. The nanomaterial of claim 4, wherein the particles are spherical, rod-shaped, star-shaped, or polygonal.

6. The nanomaterial of claim 5, wherein the particles are spherical.

7. The nanomaterial of claim 6, wherein the particles comprise an average diameter of about 50 nm across their largest diameter and are comprised of unique particle phases with average diameters less than 30 nm.

8. The nanomaterial of any of claims 1-7, wherein the particles comprise a lanthanide oxide core with an external surface, wherein the external surface comprises different constituents in different valence states.

9. The nanomaterial of claim 8, wherein M¹ and M² comprise a valence state selected from 0, +2, +3, or +4, or a combination thereof, where the valence state of M¹ and M² is the same or different, and wherein R comprises a valence state selected from +3, +4, or a combination thereof.

10. The nanomaterial of claim 9, wherein R comprises a mixed valence state with a ratio of R (3+):R (4+) percentages, wherein the ratio is about 80%: 20% to about 20%: 80%, about 75%: 25% to about 25%: 75%, about 60%: 40% to about 25%: 75%, or about 57%: 43% to about 27%: 73%.

11. The nanomaterial of claim 10, wherein the percentage of R (3+) relative to R (4+) is >50% R (3+). In a specific embodiment, R is Ce.

12. A method of producing RₓO_{y}M¹M² nanoparticles, the method comprising
dissolving a lanthanide salt (e.g. Ce(NO3)3) in water to form a lanthanide solution at a concentration of 5 mM to about 50 mM;
dissolving a first metal salt in water and a second metal salt in water at concentrations up to 20 mol % for each metal component, optionally the first metal salt and second metal salt being dissolved in the same or different solutions;
hydrolyzing the lanthanide to form lanthanide oxide; and
mixing the first metal and second metal salt solution(s) with the lanthanide solution during the hydrolyzing step to form a lanthanide/metal mixture; and
aging lanthanide/metal mixture to form RₓO_{y}M¹M² nanoparticles, where R is one or more lanthanides selected from La, Ce, Pr, Nd, Pm, Sm Eu, Gd, Tb, Dy, Ho, Er, Tm, Yb or Lu, wherein O is oxygen and where M¹ and M² are metallic components selected from Sc, Ti, V, Cr, Mn, Fe, Co, Ni, Cu, Zn, Y, Zr, Nb, Mo, Tc, Ru, Rh, Pd, Ag, or Cd, or a metal oxide thereof, wherein x is 1-3 and y is 1-3.
